(19) United States
(12) Patent Application Publication
(10) Pub. No.: US 2019/0321917 A1
(43) Pub. Date: Oct. 24, 2019

(54) MANUFACTURING OF CERMET ARTICLES BY POWDER BED FUSION PROCESSES

(71) Applicant: Department of the Army, U.S. Army CCDC Army Research Laboratory, Adelphi, MD (US)

(72) Inventors: Nicholas Ku, Havre de Grace, MD (US); John J. Pittari, III, Belcamp, MD (US); Steven M. Kilczewski, Belcamp, MD (US); Andelle D. Kudzal, Waldorf, MD (US); Jeffrey J. Swab, Fallston, MD (US); Brady B. Aydelotte, Rising Sun, MD (US)

(21) Appl. No.: 16/458,878

(22) Filed: Jul. 1, 2019

Related U.S. Application Data
(63) Continuation-in-part of application No. 15/807,604, filed on Nov. 9, 2017.

(51) Int. Cl. B23K 26/342; B33Y 10/00; B33Y 70/00; B23K 26/00; B23K 26/08

(52) U.S. Cl. CPC B23K 26/342; B33Y 10/00; B33Y 70/00; B33Y 30/00; B23K 26/0093; B23K 26/0876; B23K 26/0006

(57) ABSTRACT

A method for fabricating tungsten carbide cermet components or parts employs powder bed fusion of powder mixture of ceramic particles and metal binder. Some embodiments also include a step of hot isostatic pressing to increase the density of the part.

### CROSS REFERENCE TO RELATED APPLICATION

This application is a continuation-in-part of U.S. Non-Provisional patent application Ser. No. 15/807,604 filed on Nov. 9, 2017 which claims the benefit of U.S. Provisional Patent Application No. 62/420,332 filed on Nov. 10, 2016, the contents of which, in their entireties, are herein incorporated by reference.

### GOVERNMENT INTEREST

The embodiments herein may be manufactured, used, and/or licensed by or for the United States Government without the payment of royalties thereon.

### BACKGROUND

### Technical Field

The embodiments herein generally relate to a method for manufacturing cermet parts using powder bed fusion processes that employ directed energy, such as but not limited to selective laser melting (SLM), selective laser sintering (SLS), or direct metal laser sintering (DMLS).

### Description of the Related Art

Within this application there are several patents and publications that are referenced. The disclosures of all these patents and publications, in their entireties, are hereby expressly incorporated by reference into the present application.

Tungsten carbide (WC) cermet parts are usually made of WC particles in a metallic binder phase. Such combinations of a ceramic such as WC and a metal binder, such as cobalt, iron, nickel, and/or other metals or alloys, are part of a class of materials known as cermets. The word cermet is a contraction of the words ceramic and metal. WC cermet is a hard material used in many applications, such as armor-piercing projectiles, cutting tools, wear parts, and jewelry.

U.S. Pat. No. 6,215,093, issued to Meiners et al. on Apr. 10, 2001, proposes methods for forming a metallic body by depositing layers of powdered metal, each layer corresponding to a cross-sectional layer of the body, and then using a laser to melt the layer of powdered metal such that the layer is fused to the body being formed.

U.S. Patent Application Publication No. US20160121430A1, by Deiss et al., published on May 5, 2016, proposes a method for the production of a component by selective laser melting. Deiss et al. use an array of lasers to create a laser field. The lasers are then selectively turned on and off to melt a powdery material at selected locations to form the component.

U.S. Patent Application Publication No. US20160236372A1, by Benichou et al., published on Aug. 18, 2016, proposes tungsten-carbide/cobalt ink composition for three dimensional (3D) inkjet printing. The ink comprises a dispersion of tungsten carbide and cobalt particles in a liquid carrier that can be applied through the ink jet printer heads of 3D printers to form 3D printed objects. The 3D printed objects are then subjected to heat treatment to obtain the final product.

U.S. Patent Application Publication No. US20160332236A1, by Pantcho Stoyanov, published on Nov. 17, 2016, proposes cutting tools made by additive manufacturing. The cutting tools have an internal cavity and are formed from a powder using binder jetting and subsequent sintering.

U.S. Patent Application Publication No. US20170072469A1, by Maderud et al., published on Mar. 16, 2017, proposes a method of making cermet or cemented carbide powder that can be used in additive manufacturing techniques such as 3D printing by jetting a liquid binder. In this technique, the powder is spread out in a layer and a liquid binder is selectively sprayed in accordance with a digital model. This process is repeated until a 3D-printed “green” body is formed. A sintering process is applied to the green body to form a sintered product. The sintered body may also be processed in a hot isostatic press.

There are no current methods for manufacturing WC cermets that avoid the problems of green body formation of poorly compacted powder and machining high hardness WC cermet parts to final dimensions. Due to the high hardness of WC, machining of the densified material is very time and cost intensive. Also, the subtractive nature of the machining process limits the complexity of part shapes. Therefore, there is a need to develop a method for manufacturing WC cermet parts that overcomes the aforementioned problems.

### SUMMARY

In view of the foregoing, an embodiment herein provides a rapid method for manufacturing complex shaped parts by additive manufacturing using powder bed fusion, such as, but not limited to, selective laser melting (SLM), with a metal binder. SLM utilizes an infrared laser to locally interact with a loose powder bed. The WC powder bed can be locally fused and densified by controlling the laser to form complex parts of the material, and the binder content of the powder bed can be varied for spatial tailoring and control of useful properties which may include, by way of example but not by limitation, mechanical behavior, thermal properties, electrical properties, magnetic properties, and sonic properties for improved performance.

The embodiments herein allow near net shape manufacturing of tungsten carbide (WC) cermet products by Selective Laser Melting (SLM). “Near net shape” is a term of art and refers to a product having dimensions that are very close to the final desired dimensions for the product such that the need for further finishing operations is reduced.

Some embodiments herein use selective laser melting (SLM), which utilizes a laser to locally melt particles in a powder bed, thus fusing the particles together. The melting temperatures of ceramics are generally higher than metals. Cermets, or ceramic-metal composites, have the advantage of using a lower melting point metal as a binder phase to hold together the higher melting point ceramic particles. The effectiveness of the disclosed methods has been demonstrated using WC ceramic particles with an iron-based ternary alloy binder to fabricate a cermet.

The effectiveness of the methods disclosed herein has been verified through the printing of tungsten carbide cermet parts with various laser print parameters. Optical and electron microscopy have been conducted to confirm the densified microstructure. Archimedes density has been measured to determine the level of densification both after printing and post-print hot isostatic pressing.

The embodiments disclosed herein provide for the near net-shape manufacturing of the core material in armor-piercing projectiles used in numerous military weapon systems. The embodiments disclosed herein provide for the near net-shape manufacturing of WC cermet parts, including cutting tools, knives, hammers, mining and drilling inserts, and road scarfing inserts. The embodiments disclosed herein provide for the near net-shape manufacturing of WC cermet parts, including jewelry. The embodiments disclosed herein provide for the near net-shape manufacturing of parts for bearing and seal applications, such as bearings and rollers with increased resistance to fatigue and contact damage; of high strength functionally graded magnetic materials; of high strength materials with engineered heat flow for improved cooling; and of parts with built in circuit pathways for damage detection. The embodiments disclosed herein provide for the near net-shape manufacturing of WC cermet parts, including structural materials with engineered sound wave propagation properties.

The methods disclosed herein reduce and/or eliminate the need for costly post-process machining. Furthermore, these methods enable the formation of parts with complex shapes that subtractive processing methods, such as machining, do not allow. Use of these methods allows for spatial control of binder content, which may be used to tailor the mechanical behavior of materials and improve the performance of the parts.

The embodiments herein provide methods for additive manufacturing of a cermet part. In one embodiment, the method comprises feeding of ceramic particles, feeding of binder particles, mixing the ceramic particles and the binder particles to obtain a powder mixture, and selectively melting the binder particles in small volumes of the powder mixture at predetermined locations within the powder mixture using one or more laser beams from one or more lasers to form the cermet part. In some embodiments, the method further comprises the step of pressing the cermet part in a hot isostatic pressing process to further densify the cermet part.

Some embodiments herein are directed to a cermet part made of a material comprising tungsten carbide particles in a binder matrix made of an iron-nickel-zirconium alloy where the material of the cermet part has been densified.

An embodiment herein provides a method for additive manufacturing of a cermet part, the method comprising providing ceramic particles; providing binder particles; incorporating the ceramic particles and the binder particles into a powder bed comprising the ceramic particles and the binder particles; and selectively melting the binder particles at predetermined locations within the powder bed using one or more directed energy sources to form the cermet part. The method may further comprise the step of pressing the cermet part in a hot isostatic pressing process to further densify the cermet part.

The powder bed may comprise from about 2% to about 25% by weight of the binder particles and from about 75% to about 98% by weight of the ceramic particles. The powder bed may comprise from about 10% to about 20% by weight of the binder particles and from about 80% to about 90% by weight of the ceramic particles. The powder bed may comprise about 10% by weight of the binder particles and about 90% by weight of the ceramic particles. The powder bed at no time contains an organic polymer binder. The powder bed at no time contains an organic compound. The binder particles may be selected from a metal or metal alloy. The binder particles may be made of an iron-based ternary alloy. The binder particles may be made of an iron-nickel-zirconium alloy. The ceramic particles may comprise any of tungsten carbide, cubic boron nitride, titanium carbide, boron carbide, silicon carbide, silicon nitride, aluminum oxide, tantalum carbide, and mixtures thereof. The ceramic particles may be made of tungsten carbide and the binder particles are made of an iron-based ternary alloy. The ceramic particles may be made of tungsten carbide and the binder particles are made of an iron-nickel-zirconium alloy.

The step of selectively melting the binder particles may comprise providing a layer of a powder of controlled thickness, the layer comprising the ceramic particles and the binder particles; subjecting the layer to a rastering process using the one or more directed energy sources to selectively melt the binder particles in spatial regions of the layer corresponding to a portion of the cermet part being formed; and repeating at least the steps of providing a layer of a powder and subjecting the layer to a rastering process until at least the initial formation of the cermet part is complete, wherein each layer of powder comprising the ceramic particles and the binder particles is deposited on top of at least the regions of the previous layer subjected to melting to build up the cermet part. A number of layers of powder comprising the ceramic particles and the binder particles that are deposited as a result of the repeated step of providing a layer of a powder may form the powder bed.

The cermet part formed at the conclusion of the step of selectively melting the binder particles may have a density in the range of from about 77% to about 95% of a theoretical maximum density. The cermet part formed at the conclusion of the step of selectively melting the binder particles may have a density of about 95% of a theoretical maximum density. The proportion of the binder particles to the ceramic particles may be controlled and varied as necessary, at least at the regions of the powder bed corresponding to a portion of the cermet part, to provide for functionally graded mechanical, thermal, magnetic, electrical, vibrational, or sonic properties in the material of the cermet part. The binder particles may be made of a metal or metal alloy comprising any of cobalt and an iron-based ternary alloy, and wherein the ceramic particles comprise any of tungsten carbide, cubic boron nitride, titanium carbide, boron carbide, silicon carbide, silicon nitride, aluminum oxide, tantalum carbide, and mixtures thereof. The one or more directed energy sources may be one or more lasers.

These and other aspects of the embodiments herein will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates the micro structure of the ceramic particles and binder particles mixture before selective laser melting, according to the embodiments herein;

FIG. 2 illustrates the micro structure of the cermet part after the selective laser melting process is complete, comprised of the ceramic particles and binder matrix, according to the embodiments herein;

FIG. 3 is a flow diagram illustrating an embodiment of a method for additive manufacturing of a cermet part, according to the embodiments herein;

FIG. 4 is a flow diagram illustrating an example of a process that may be used for the step of selectively melting the binder particles in the method of FIG. 3, according to the embodiments herein;

FIG. 5 is a diagrammatic illustration of an example of an apparatus that may be used for depositing a layer of the ceramic particle and binder particle mixture in the process of FIG. 4, according to the embodiments herein;

FIG. 6 is a diagrammatic illustration of an example of an apparatus that may be used for subjecting the layer of the ceramic particle and binder particle mixture to a laser rastering process in the process of FIG. 4, according to the embodiments herein;

FIG. 7 is a diagrammatic illustration of an example of an apparatus that may be used for moving the laser over the layer of the ceramic particle and binder particle mixture during the laser rastering process, according to the embodiments herein;

FIG. 8 is a diagrammatic illustration of an example of an apparatus that may be used for moving a dispenser containing the ceramic particle and binder particle mixture during the step of depositing the layer of the ceramic particle and binder particle mixture, according to the embodiments herein;

FIG. 9 is a flow diagram illustrating an optional step that may be employed during the step of mixing the ceramic particles and the binder particles to obtain a powder mixture in the method of FIG. 3, according to the embodiments herein;

FIG. 10 is a diagrammatic illustration of a second example of an apparatus that may be used for depositing a layer of the ceramic particle and binder particle mixture in the process of FIG. 4, according to the embodiments herein;

FIG. 11 is a diagrammatic illustration of a third example of an apparatus that may be used for depositing a layer of the ceramic particle and binder particle mixture in the process of FIG. 4, according to the embodiments herein; and

FIG. 12 is a diagrammatic illustration of a fourth example of an apparatus that may be used for depositing a layer of the ceramic particle and binder particle mixture in the process of FIG. 4, according to the embodiments herein.

### DETAILED DESCRIPTION

The embodiments herein and the 138 features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

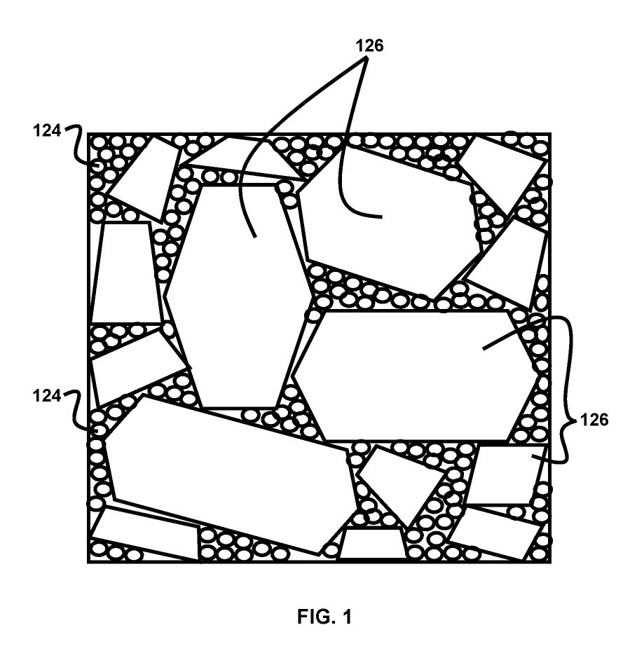

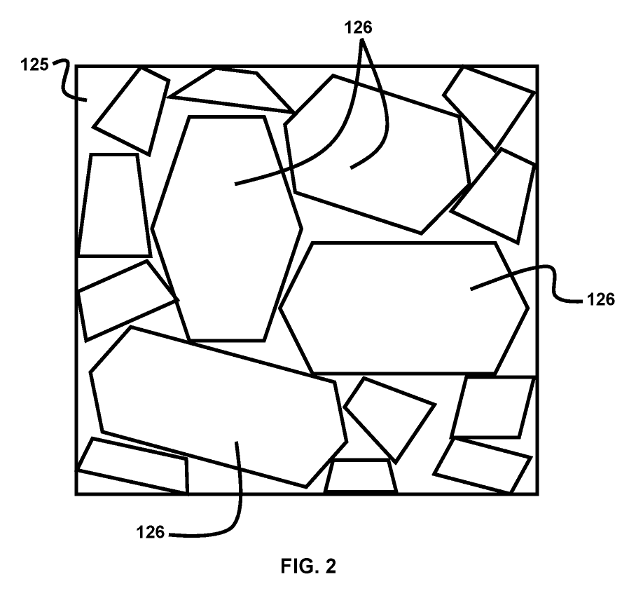

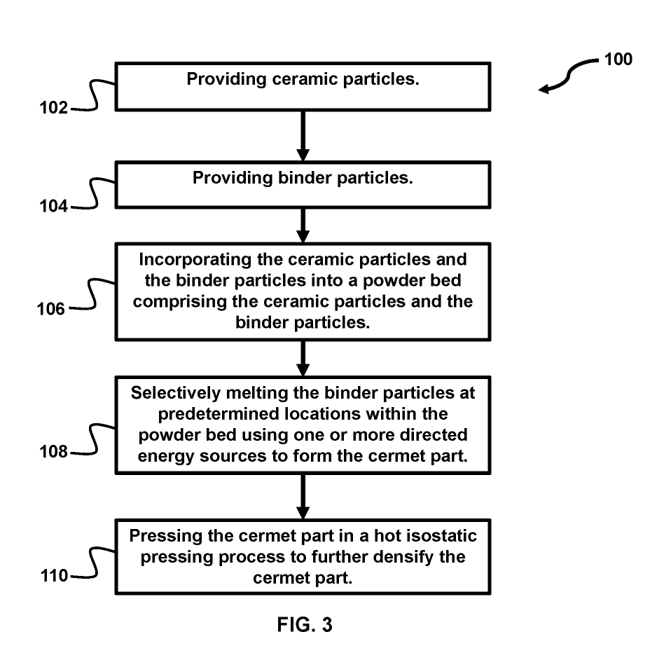

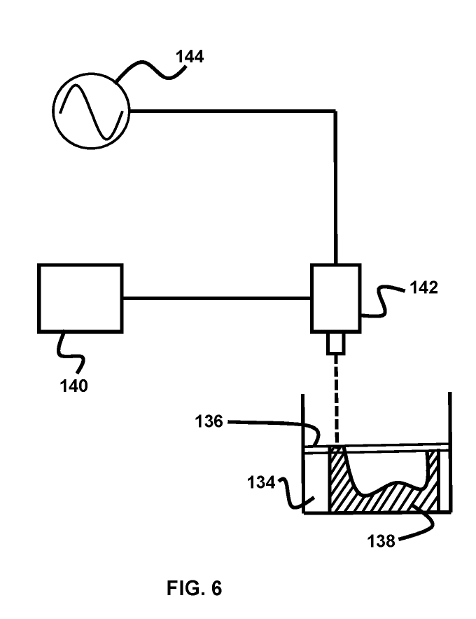

Referring to FIGS. 1-8, the embodiments herein provide methods for additive manufacturing of a cermet part 138, which is shown during fabrication in an incomplete state in the illustrated examples. In one embodiment, the method 100 comprises providing (102) ceramic particles 126, providing (104) binder particles 124, incorporating (106) the ceramic particles and the binder particles into a powder bed 134 comprising the ceramic particles and the binder particles, and selectively melting (108) the binder particles at predetermined locations within the powder bed using one or more directed energy sources 142 to form the cermet part 138. In some embodiments, the method further comprises the step of pressing (110) the cermet part in a hot isostatic pressing process to further densify the cermet part.

The directed energy sources may be any directed energy source capable of melting the metallic binder and wetting the ceramic particles. Examples of suitable directed energy sources include, but are not limited to, lasers, electron beams, plasmas, microwaves, etc. In the illustrative examples herein, a laser providing a beam that can be scanned in a rastering process was used as the directed energy source.

In some embodiments, the powder bed comprises from about 2% to about 25% by weight of the binder particles and from about 75% to about 98% by weight of the ceramic particles. In some examples, the powder bed comprises from about 10% to about 20% by weight of the binder particles and from about 80% to about 90% by weight of the ceramic particles. In other examples, the powder bed comprises about 10% by weight of the binder particles and about 90% by weight of the ceramic particles. Accordingly, the powder bed is formed by a mixture comprising the ceramic particles and the binder particles.

In some embodiments, the powder mixture at no time contains an organic polymer binder or an organic compound. In other embodiments, an organic polymer binder or an organic compound may be used to bind together metallic binder particles and/or ceramic particles into particles of the desired size for use in the powder bed or powder mixture. The binder particles are selected from a metal or metal alloy. In some examples, the binder particles are made of cobalt. In some examples, the binder particles are made of an iron-based ternary alloy. In some examples, the binder particles are made of an iron-nickel-zirconium alloy. In some examples, the binder particles do not include cobalt where the toxicity or carcinogenicity of cobalt would be undesirable.

U.S. Patent Application Publication No. US 2018/0142331 A1, by Pittari et al., published on May 24, 2018, proposes a substantially cobalt-free binder including an iron-based alloy sintered with the tungsten carbide that are desirable in certain embodiment of the present invention. The iron-based alloy is approximately 2-25% of the overall weight percentage of the sintered tungsten carbide and iron-based alloy. The iron-based alloy may be sintered with the tungsten carbide using a uniaxial hot pressing process, a spark plasma sintering process, or a pressure-less sintering process.

In some embodiments, the ceramic particles comprise particles comprising any of tungsten carbide (WC), cubic boron nitride (c-BN), titanium carbide (TiN), boron carbide (BC), silicon carbide (SiC), silicon nitride (SiN), aluminum oxide (Al₂O₃), tantalum carbide (TaC), other high hardness ceramics, and mixtures thereof. In some embodiments, the ceramic particles are made of tungsten carbide and the binder particles are made of an iron-based ternary alloy. In one example, the ceramic particles are made of tungsten carbide and the binder particles are made of an iron-nickel-zirconium alloy.

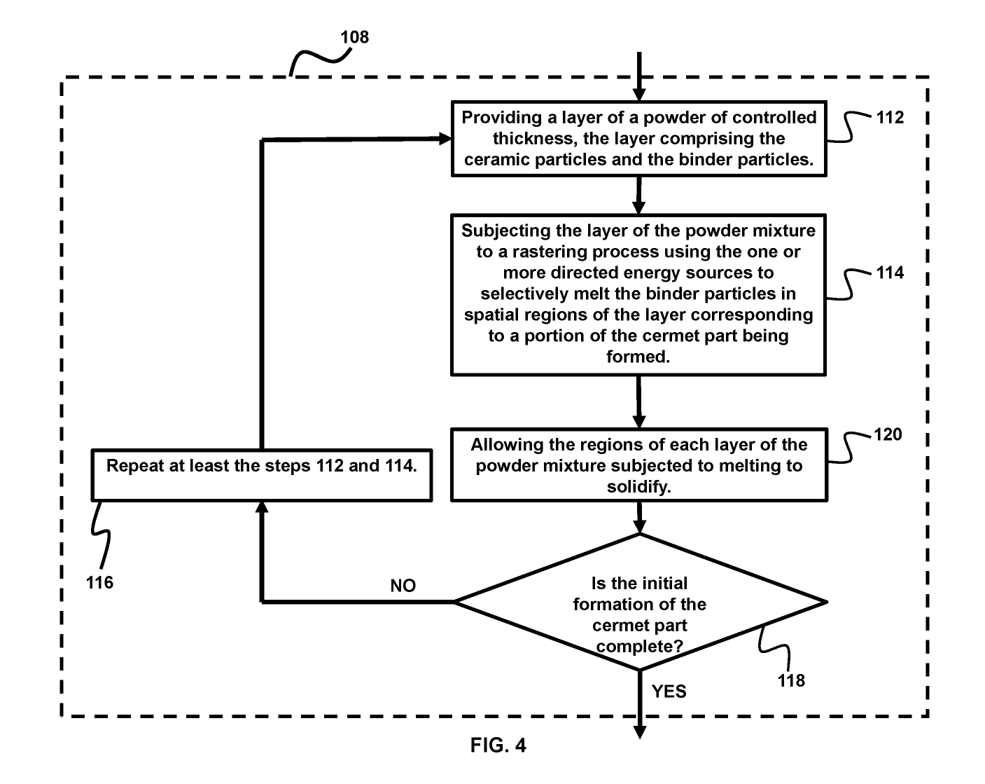

In some embodiments (see FIG. 4), the step of selectively melting (108) the binder particles may include multiple steps. A first step may comprise providing (112) a layer 136 of the powder or powder mixture, comprising the ceramic particles and the binder particles, of controlled thickness. A second step may comprise subjecting (114) the layer of the powder mixture to a rastering process using one or more directed energy sources 142 to selectively melt the binder particles in spatial regions of the layer corresponding to a portion of the cermet part being formed. The step of selectively melting the binder particles may further comprise repeating (116) at least the steps of providing (112) a layer of the powder mixture and subjecting (114) the layer of the powder mixture to a rastering process until at least the initial formation of the cermet part is complete. The condition for the completion of the initial formation of the cermet part is tested at decision structure 118. Each layer of the powder mixture is deposited on top of at least the regions of the previous layer subjected to melting to build up the cermet part. The step of selectively melting the binder particles may further comprise a step of allowing (120) the regions of each layer of the powder mixture subjected to melting to solidify before a subsequent layer of powder mixture is deposited, but this step may not usually be necessary as there is sufficient time lapse during the rastering process and deposition of the subsequent powder layer to allow for any solidification of the melted binder if needed.

In some embodiments the rastering process is a laser rastering process using a laser 142 with a controllable power and rastering speed to selectively melt the binder particles in spatial regions of the layer corresponding to a portion of the cermet part being formed. During the rastering process, the laser or directed energy source may be scanned over the layer of powder or powder bed, or the laser or directed energy source may be held stationary while the powder bed is moved in the x and y directions to bring the desired region of the powder layer 136 or the powder bed 134 into the path of the laser beam or other directed energy source.

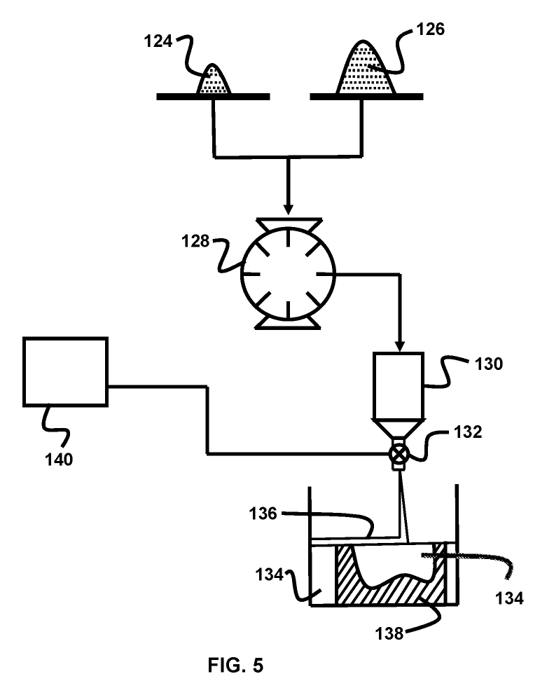

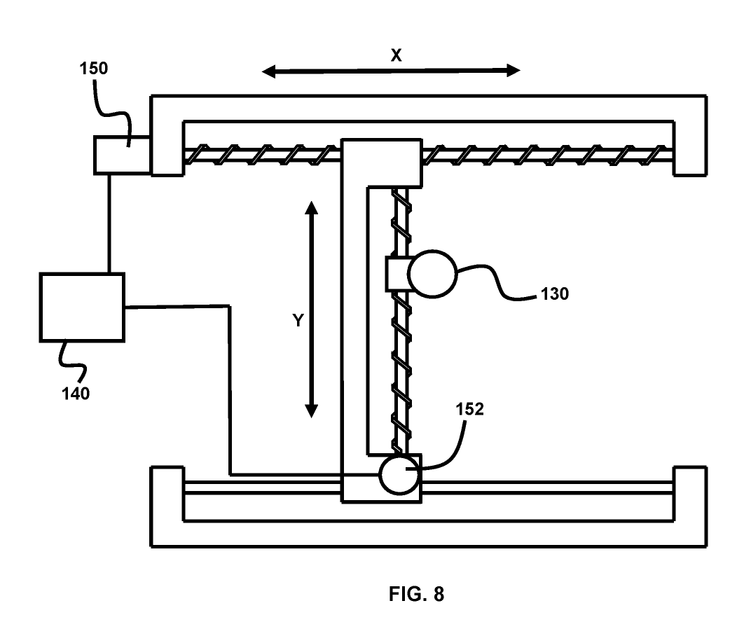

Referring to FIGS. 5-8, ceramic particles 126 and binder particles 124 are mixed in a mixer 128 to form a powder mixture 134. The powder mixture is supplied to a hopper 130. The powder mixture is dispensed from the hopper 130 under the control of computerized controller 140 to deposit each layer 136 of powder mixture of controlled thickness. The computerized controller 140 controls the dispensing of powder mixture from the hopper 130 by controlling the valve or dispenser 132, and the computerized controller 140 controls the movement and position of the hopper 130 to spread the layer of powder mixture 136 over the desired area using, for example, a servomechanism as illustrated in FIG. 8. The computerized controller 140 controls servomotors 150 and 152 to control the X and Y coordinates and movement of the hopper 130 over the area in which the layer 136 is to be formed.

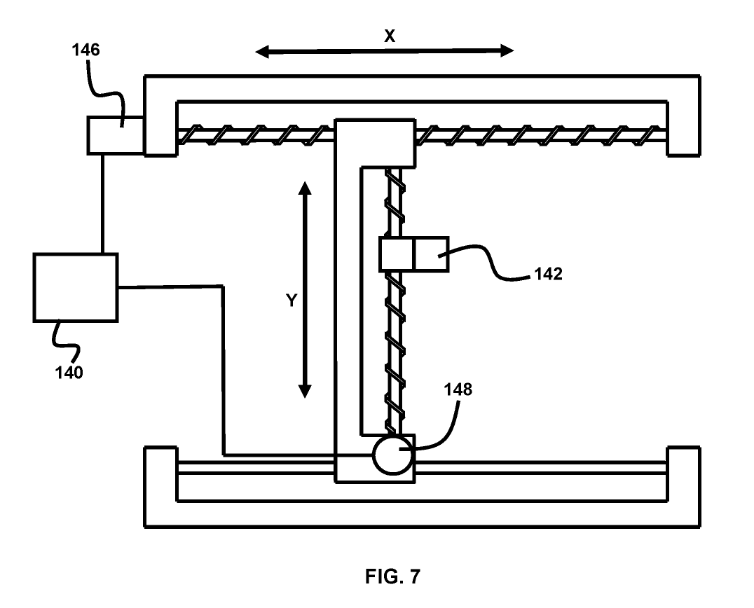

The laser 142 is then used to melt the binder particles 126 to form the binder matrix 125 in spatial regions of the layer 136 corresponding to a portion of the cermet part 138 being formed. The power output of the laser and the locations in each layer 136 that are to be melted to form the cermet part are controlled by the computerized controller 140 in accordance with a digital model of the cermet part, the physical properties of the material used, and other parameters that are programmed into the memory or data storage system of the computerized controller 140. The computerized controller 140 controls the movement and position of the laser 142 to selectively melt the binder particles only in locations in the layer 136 corresponding to a portion of the cermet part 138. The computerized controller 140 controls the movement and position of the laser 142 over the area of the layer 136 using, for example, a servomechanism as illustrated in FIG. 7. The computerized controller 140 controls servomotors 146 and 148 to control the X and Y coordinates and movement of the laser 142 over the area in which the layer 136 is formed. Alternatively, mirrors may be used to scan the laser beam from laser 142 over the area of the layer 136. The power supply 144 provides the power for energizing the laser 142. The depositing of layers of powder 136 and selective melting of the binder particles in the regions of each layer corresponding to a portion of the cermet part are repeated until the cermet part is completed to close to its final form at least in terms of its shape and geometric proportions.

In some embodiments, the cermet part formed at the conclusion of the step of selectively melting the binder particles has a density in the range of from about 77% to about 95% of a theoretical maximum density. In other embodiments, the cermet part formed at the conclusion of the step of selectively melting the binder particles has a density of about 95% of a theoretical maximum density.

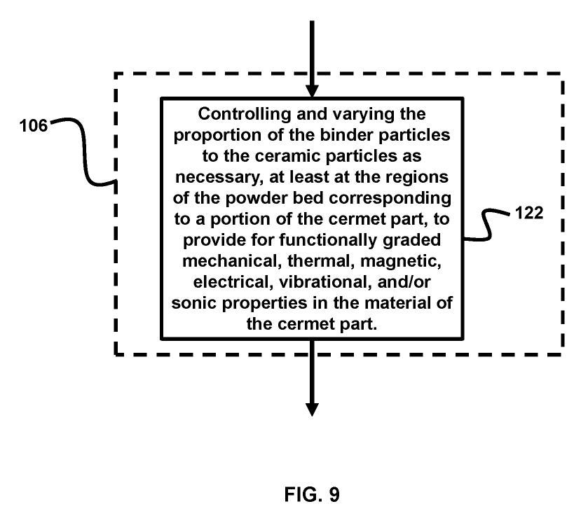

In some examples (see FIG. 9), the proportion of the binder particles to the ceramic particles is controlled and varied (122) as necessary, at least at the regions of the powder bed corresponding to a portion of the cermet part, to provide for functionally graded mechanical, thermal, magnetic, electrical, vibrational, and/or sonic properties in the material of the cermet part. The proportion of the binder particles to the ceramic particles may be varied within each layer, at least at the regions of each powder layer corresponding to a portion of the cermet part, and also from one layer to another to provide the functionally graded properties in the material of the cermet part.

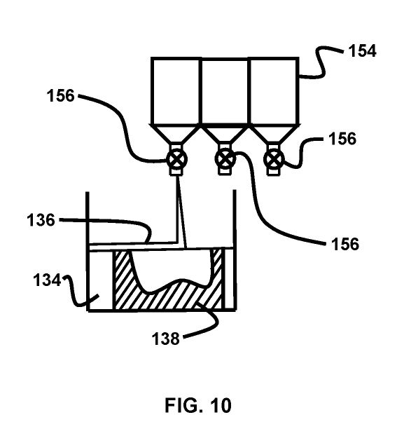

Referring to FIG. 10, the proportion of the binder particles to the ceramic particles can be varied by using a multi-compartment hopper 154. Each compartment of the hopper has a powder mixture with a different proportion of the binder particles to the ceramic particles. The computerized controller 140 controls outlet valves or dispensers 156 for each compartment and a servo mechanism, for example like that illustrated in FIG. 8, for positioning the compartment with the mixture of the desired ceramic to binder ratio over the desired location in the layer 136 being deposited. The computerized controller 140 selectively delivers a mixture with the desired proportion of ceramic particles to binder particles to different locations in each layer 136 to thus control the gradation of material properties within the cermet part 138.

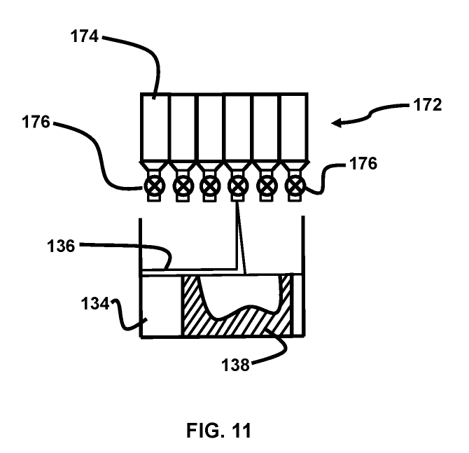

Alternatively, each location in the layer may have its own dedicated hopper or hopper compartment 174 that is charged with the powder mixture of the desired proportion of binder to ceramic for that location as shown in FIG. 11. The controller would then only be required to operate the outlet valves or dispensers 176 of the hoppers or hopper compartments 174 once the charging of the hoppers or hopper compartments is complete in order to deposit a powder layer 136 with the desired compositional variation. The hopper compartments 174 are provided in a two dimensional array 172 over the area in which the layers 136 are being deposited.

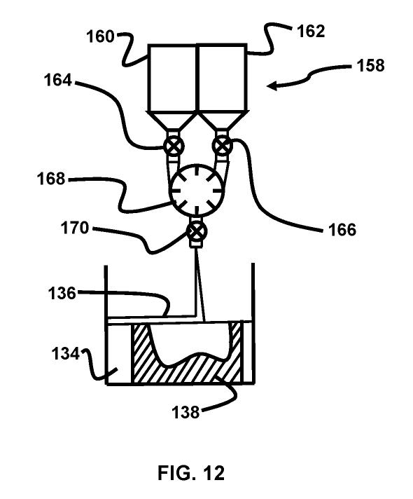

Referring to FIG. 12, the proportion of the binder particles to the ceramic particles can be varied by using a two-compartment hopper 158. One compartment 160 of the hopper contains the ceramic particles 126 while the other compartment 162 contains the binder particles 124. A computerized controller, such as computerized controller 140, controls outlet valves or dispensers 164 and 166 for each compartment to deliver ceramic and binder particles in the right proportions to a mixer 168. The computerized controller 140 then controls an outlet valve or dispenser 170 of the mixer and a servo mechanism, for example such as that illustrated in FIG. 8, for positioning the outlet valve or dispenser 170 of the mixer over the desired location in the layer being deposited. Thus, the computerized controller 140 selectively delivers a mixture with the desired proportion of ceramic to binder particles to different locations in each layer 136 to thus control the gradation of material properties within the cermet part 138. The hopper system of FIG. 12 may also be employed in conjunction with the hoppers in FIGS. 10 and 11 to fill the compartments in those hoppers with powder mixtures having the desired proportions of ceramic particles to binder particles.

The mixers 168 and 128 may be of any suitable type for mixing particulate or granular material. In the illustrated examples, the mixers 168 and 128 are of the rotary drum type. The valves or dispensers 132, 156, 176, 164, 166, and 170 may be of any suitable type for dispensing particulate or granular material. For example, the valves or dispensers 132, 156, 176, 164, 166, and 170 may be of types including, without limitation, hinged flaps, gate valves, ball valves, rotary auger type dispensers, and rotary volumetric dispensers.

Some embodiments herein are directed to a cermet part made of a material comprising tungsten carbide particles in a binder matrix 125 made of an iron-nickel-zirconium alloy where the material of the cermet part has a density in the range of about 77% or higher of a theoretical maximum density. Further embodiments herein are directed to a cermet part made of a material comprising tungsten carbide particles in a binder matrix 125 made of an iron-nickel-zirconium alloy where the material of the cermet part has a density in the range of about 95% or higher of a theoretical maximum density.

Some embodiments herein are directed to the additive manufacturing of a tungsten carbide (WC) cermet using selective laser melting. The intimately mixed WC-binder powder is loaded into the SLM printer. A layer of powder of controlled thickness is subjected to a laser with a controllable power and rastering speed. After the laser raster is complete, a second layer of powder is deposited on top to continue the build-up of material. Densities of the printed parts ranged from 77% to 95% theoretical density. Hot isostatic pressing of the printed parts was shown to increase part densities to near maximum theoretical values.

The embodiments herein address two major challenges in the traditional processing of the cermet material: green body formation of the poorly compacted powder and near-net shape manufacturing of difficult to machine parts. The WC-binder mixture is difficult to dry press into green powder compacts. Due to the high hardness of WC, machining of the densified material is very time and cost intensive, as well as the subtractive nature of the processing limits the complexity of part shapes. Attributable to the additive nature of the embodiments herein, changes in the powder composition (WC versus binder content) can be made between each layer. This functional grading by spatial control of binder content can lead to advanced and tailored mechanical performance, with harder cutting surfaces supported by more ductile backing. Spatial control over binder content and reinforcement content also can improve fatigue life and resistance to contact induced damage by adding more ductile material where cyclic loading or contact is expected. Spatial control over binder content can also allow designing in paths for heat conduction to improve cooling. Spatial control over binder content also allows spatial control of magnetic properties to create high strength materials with graded/tailored magnetic response. Spatial control over electrical conductivity will allow engineering of conductive paths through the material for controlled electrical flow, 3D engineered circuits, and damage detection. Spatial control over binder content also will change the relative sound speed in regions of the material. This may be useful for damping vibration and controlling sound wave propagation.

The embodiments herein eliminate costly machining of the densified material due to the high material hardness of cermets. The methods herein permit the near-net shape manufacturing of cutting tools for the cutting and/or machining of steels, hard metals, metal alloys and abrasion resistant materials; of inserts in the mining and drilling of rock and earthen material in the coal, oil and gas industry; of knives and hammers; of bearings and seals; and of armor-piercing projectiles.

The embodiments herein have further advantages over previous near-net shape manufacturing methods for cermets due to the lack of any organic binder being used and the ability to sinter the material during printing. The method herein also facilitate the spatial control of binder content within the material. Furthermore, post processing of the printed parts made in accordance with the embodiments herein has shown the ability to produce near maximum theoretical density parts.

Cemented tungsten carbide (WC) has an extremely high hardness and is commonly used for wear-resistant applications, such as cutting tools, armor-piercing projectiles, and abrasives. Due to the high hardness of the material, machining of WC is often time and cost intensive. The embodiments disclosed herein allow the additive manufacturing of cemented WC to near-net-shape. Parts with densities as high as 95% of the theoretical maximum have been successfully fabricated using the methods disclosed herein. Manufacturing parts with the methods disclosed herein will eliminate the necessity to machine the parts after sintering. Furthermore, the methods disclosed herein allow for spatially controlling binder content through the part material, which provides for functionally graded mechanical, magnetic, electrical, and/or sonic properties.

In some embodiments disclosed herein, the binder phase is an iron-based alloy, which had a lower melting temperature than the cobalt binder that is commonly used in cemented WC. A cuboid specimen of WC and Fe—Ni—Zr binder material was additively manufactured with SLM. The first test resulted in the successful fabrication of a dense piece of tungsten carbide with the iron alloy binder phase. Cuboid specimens were printed, and the effect of different processing print conditions on the resultant density and microstructure of the material were investigated. Theoretical densities as high as 95% were achieved using this method.

The process conditions used for these illustrative examples were as follows:

TABLE I

| | |
|---|---|
| Layer thickness: | 30 micrometers |
| Laser beam power: | 40-100 Watts |
| Scan rates: | 50-150 mm/s |
| Hatch spacing (raster width): | 50-75 micrometers |
| Temperatures used during hot isostatic pressing: | 1350 Celsius |
| Pressures used during hot isostatic pressing: | 103.4 MPa |

The volume of the powder bed that is in a molten state, or subjected to melting, at any time during the rastering process is determined by the raster width, laser power, and scan rate. These parameters can be controlled to reduce the molten volume when high resolution is needed to produce accurate surfaces for the cermet part and to increase the molten volume when forming bulk spatial regions of the cermet part in order to speed up the rastering and/or fabrication process.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

What is claimed is:

1. A method for additive manufacturing of a cermet part, the method comprising:
providing ceramic particles;
providing binder particles;
incorporating the ceramic particles and the binder particles into a powder bed comprising the ceramic particles and the binder particles; and
selectively melting the binder particles at predetermined locations within the powder bed using one or more directed energy sources to form the cermet part.

2. The method of claim 1, further comprising the step of pressing the cermet part in a hot isostatic pressing process to further densify the cermet part.

3. The method of claim 1, wherein the powder bed comprises from about 2% to about 25% by weight of the binder particles and from about 75% to about 98% by weight of the ceramic particles.

4. The method of claim 1, wherein the powder bed comprises from about 10% to about 20% by weight of the binder particles and from about 80% to about 90% by weight of the ceramic particles.

5. The method of claim 1, wherein the powder bed comprises about 10% by weight of the binder particles and about 90% by weight of the ceramic particles.

6. The method of claim 1, wherein the powder bed at no time contains an organic polymer binder.

7. The method of claim 1, wherein the powder bed at no time contains an organic compound.

8. The method of claim 1, wherein the binder particles are selected from a metal or metal alloy.

9. The method of claim 8, wherein the binder particles are made of an iron-based ternary alloy.

10. The method of claim 9, wherein the binder particles are made of an iron-nickel-zirconium alloy.

11. The method of claim 1, wherein the ceramic particles comprise any of tungsten carbide, cubic boron nitride, titanium carbide, boron carbide, silicon carbide, silicon nitride, aluminum oxide, tantalum carbide, and mixtures thereof.

12. The method of claim 1, wherein the ceramic particles are made of tungsten carbide and the binder particles are made of an iron-based ternary alloy.

13. The method of claim 1, wherein the ceramic particles are made of tungsten carbide and the binder particles are made of an iron-nickel-zirconium alloy.

14. The method of claim 1, wherein the step of selectively melting the binder particles comprises:
providing a layer of a powder of controlled thickness, the layer comprising the ceramic particles and the binder particles;
subjecting the layer to a rastering process using the one or more directed energy sources to selectively melt the binder particles in spatial regions of the layer corresponding to a portion of the cermet part being formed; and
repeating at least the steps of providing a layer of a powder and subjecting the layer to a rastering process until at least the initial formation of the cermet part is complete, wherein each layer of powder comprising the ceramic particles and the binder particles is deposited on top of at least the regions of the previous layer subjected to melting to build up the cermet part.

15. The method of claim 14, wherein a number of layers of powder comprising the ceramic particles and the binder particles that are deposited as a result of the repeated step of providing a layer of a powder form the powder bed.

16. The method of claim 1, wherein the cermet part formed at the conclusion of the step of selectively melting the binder particles has a density in the range of from about 77% to about 95% of a theoretical maximum density.

17. The method of claim 1, wherein the cermet part formed at the conclusion of the step of selectively melting the binder particles has a density of about 95% of a theoretical maximum density.

18. The method of claim 15, wherein the proportion of the binder particles to the ceramic particles is controlled and varied as necessary, at least at the regions of the powder bed corresponding to a portion of the cermet part, to provide for functionally graded mechanical, thermal, magnetic, electrical, vibrational, or sonic properties in the material of the cermet part.

19. The method of claim 1, wherein the binder particles are made of a metal or metal alloy comprising any of cobalt and an iron-based ternary alloy, and wherein the ceramic particles comprise any of tungsten carbide, cubic boron nitride, titanium carbide, boron carbide, silicon carbide, silicon nitride, aluminum oxide, tantalum carbide, and mixtures thereof.

20. The method of claim 1, wherein the one or more directed energy sources are one or more lasers.
